(19) United States
(12) Patent Application Publication
(10) Pub. No.: US 2026/0095215 A1
(43) Pub. Date: Apr. 2, 2026

(54) TECHNOLOGIES FOR PRECODING MATRIX WITH PHASE CALIBRATION ERROR COMPENSATION

(71) Applicant: Apple Inc., Cupertino, CA (US)

(72) Inventors: Haitong Sun, Saratoga, CA (US); Ankit Bhamri, Haar (DE); Chunxuan Ye, San Diego, CA (US); Dawei Zhang, Saratoga, CA (US); Hong He, San Jose, CA (US); Huaning Niu, San Jose, CA (US); Sigen Ye, San Diego, CA (US); Wei Zeng, Saratoga, CA (US)

(73) Assignee: Apple Inc., Cupertino, CA (US)

(21) Appl. No.: 19/111,298

(22) PCT Filed: Sep. 6, 2023
(86) PCT No.: PCT/US2023/032027

§ 371 Date: Mar. 12, 2025

Related U.S. Application Data
(60) Provisional application No. 63/408,789, filed on Sep. 21, 2022.

(51) Int. Cl. H04B 7/0456; H04L 5/00

(52) U.S. Cl. CPC H04B 7/0456; H04L 5/0044

(57) ABSTRACT

The present application relates to devices and components including apparatus, systems, and methods for compensating phase calibration errors in physical uplink shared channel transmissions.

### RELATED APPLICATION

This disclosure claims priority to U.S. Provisional Application No. 63/408,789, filed Sep. 21, 2022, which is hereby incorporated by reference in its entirety.

### FIELD

This disclosure relates to the field of wireless communications and, in particular, to technologies for precoding matrix with phase calibration error compensation.

### BACKGROUND

Current New Radio (NR) networks support two uplink multiple-input, multiple-output (MIMO) operation modes. A first mode comprises codebook-based physical uplink shared channel (PUSCH) operation in which precoding and number of layers is indicated by transmit precoding matrix indicator (TPMI) value in a scheduling DCI. The TPMI may refer to precoders defined in Third Generation Partnership Project (3GPP) Technical Specification (TS) 38.211 v17.2.0 (2022-06-23). A second mode comprises a non-codebook-based PUSCH operation in which the precoding and number of layers is indicated by a sounding reference signal resource indicator (SRI) value in the scheduling DCI.

Currently, New Radio (NR) TSs supports three different coherency modes for codebooks used for uplink MIMO operation. These include a non-coherent codebook, partial-coherent codebook, and a full coherent codebook. NR TSs support a maximum of four transmit antenna ports and four-layer physical uplink shared channel (PUSCH) for uplink MIMO operation.

### BRIEF DESCRIPTION OF THE DRAWINGS

FIG. 1 illustrates a network environment, in accordance with some embodiments.

FIG. 2 illustrates a phase calibration compensation matrix in accordance with some embodiments.

FIG. 3 illustrates phase calibration compensation matrixes with a first mapping option in accordance with some embodiments.

FIG. 4 illustrates phase calibration compensation matrixes with a second mapping option in accordance with some embodiments.

FIG. 5 illustrates a signaling diagram in accordance with some embodiments.

FIG. 6 illustrates an operational flow/algorithmic structure, in accordance with some embodiments.

FIG. 7 illustrates another operational flow/algorithmic structure, in accordance with some embodiments.

FIG. 8 illustrates an user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Efforts are being made in 3GPP to study MIMO evolution for downlink and uplink. These efforts include studying the use of eight transmit (Tx) antennas for uplink (UL) operation. An eight-Tx-antenna configuration may be employed in a user equipment (UE) such as, for example, a customer premise equipment (CPE), fixed wireless access (FWA) device, vehicle, or industrial device. Enhancement to uplink demodulation reference signals, sounding reference signals (SRSs), SRS resource indicators (SRIs), and signaling transmit precoding matrix indicators (TPMIs) may facilitate 8-Tx UL operation.

One challenge associated with 8-Tx UL operation may include the design of TPMI for coherent codebook physical uplink shared channel (PUSCH) operation. For each layer of a coherent PUSCH transmission, the network should be able to indicate a phase/amplitude coefficient that a UE should apply to each antenna port (among the eight antenna ports). Current TPMI design in NR only supports up to four antenna ports.

Current codebook designs for downlink and TPMI for uplink may not adequately address UE phase calibration error with respect to 8-Tx UL operation. For the downlink codebook, it may be assumed that the transmitter has accurate phase calibration. However, it may be hard for the UE to achieve accurate phase calibration as compared to the base station. For uplink TPMI, only two cross polarized antenna elements are assumed in existing NR TSs. Thus, phase calibration error may not be significant.

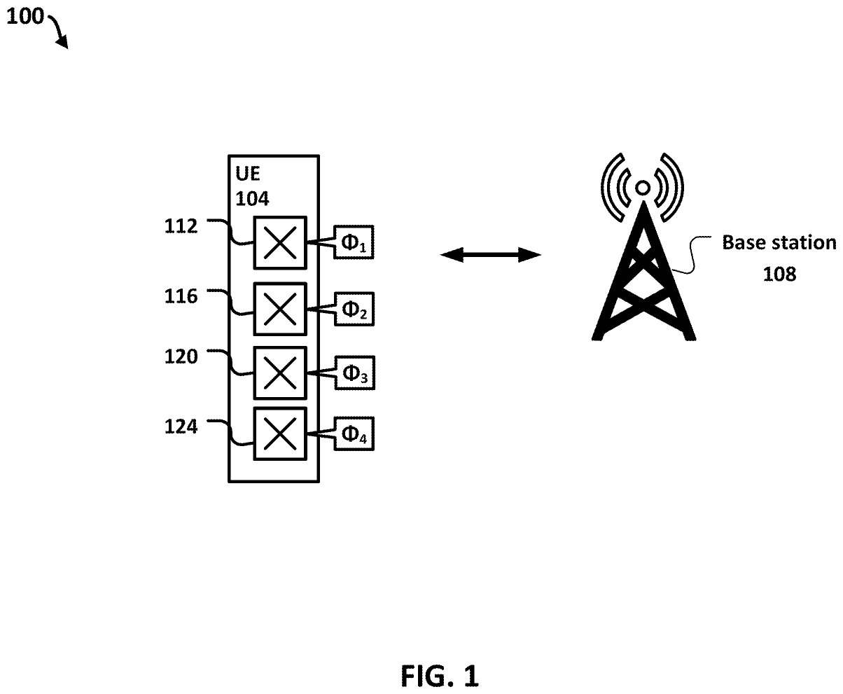

FIG. 1 illustrates a network environment 100 in accordance with some embodiments. The network environment 100 may include a UE 104 and a base station 108. The base station 108 may provide a serving cell through which the UE 104 may communicate with the base station 108. In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The UE 104 may include eight transmit antenna elements and be capable of performing an uplink transmission with four or more transmission layers. The eight Tx antenna elements may be arranged as four pairs of elements disclosed at four separate locations. For example, the Tx elements may be arranged as a first pair 112, a second pair 116, a third pair 120, and a fourth pair 124. Each pair may include a vertical-polarized (V-Pol) antenna element and a horizontal-polarized (H-Pol) antenna element. Each location may be associated with its own initial phase, e.g., Φᵢ, i=1, 2, 3, 4. A first phase (for example, Φ₁) may be set equal to 0 to serve as a reference phase for the remaining phases.

Embodiments of the present disclosure provide for TPMI design for 8-Tx coherent PUSCH operation to handle phase calibration error within the UE 104. Some aspects include phase calibration error compensation with respect to a transmit precoding matrix (TPM). Additional aspects describe use of a DL/UL type I multi-panel codebook, to compensate phase calibration errors.

For a given precoding matrix design, some embodiments apply an additional phase calibration error compensation factor/matrix using a phase calibration compensation (PCC) TPM ((Wₚ)_{N_t×RI}) defined as:

$${( {W}_{p} )}_{N \_ t \times RI} = {Φ}_{N \_ t \times N \_ t} \times {W}_{N \_ t \times RI} . \qquad Equation 1$$

In Equation 1, W_{N_t×RI} is a baseline precoding matrix from a DL/UL type I codebook, which may be similar to a legacy precoding matrix from a DL type I codebook. The baseline precoding matrix may include Nₜ, rows with each row representing a Tx antenna port; and RI columns with each column representing a transmission layer. As used herein, Tx antenna port may correspond to one or more Tx antenna elements.

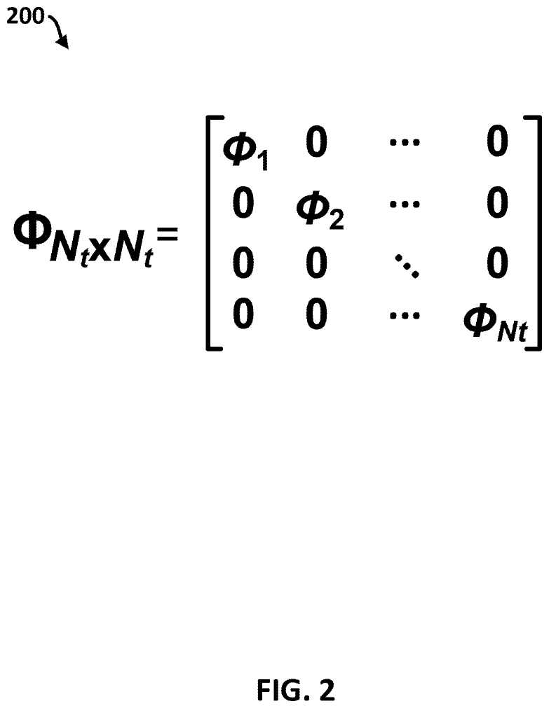

In Equation 1, Φ_{N_t×N_t} is a PCC matrix that that has the same N_t rows and columns. The PCC matrix may be a diagonal matrix in which only the diagonal elements are non-zero. FIG. 2 illustrates a PCC matrix 200 in accordance with some embodiments. Each value of Φᵢ may be referred to as a phase calibration error compensation (PCEC) value that is configured to compensate for a phase error of an associated transmit antenna port. For example, Φ₁ may be applied to transmit antenna port 1, Φ₂ may be applied to transmit antenna port 2, etc.

The PCC matrix may be applied to (for example, multiplied by) the baseline precoding matrix to generate the PCC TPM, which may be a precoding matrix the UE 104 can use for uplink transmissions that also provides for phase calibration error compensation.

The diagonal elements of the PCC matrix may include a number of unique values. The number of unique values within the PCC matrix may be set based on one or more of the following options.

In a first option, the PCC matrix may contain Nₜ/2 unique values, where Nₜ is the number of Tx ports. In this instance, the phase between a V-Pol and H-Pol antenna element at the same antenna location may be assumed to be calibrated with one another. Thus, a PCC matrix having four unique values (corresponding to the four pairs of antenna elements) may be sufficient for 8-Tx UL operation.

In a second option, the PCC matrix may contain less than Nₜ/2 unique values. In this instance, the phase between a V-Pol and H-Pol antenna element at the same antenna location may be assumed to be calibrated with one another. For example, the PCC matrix may include two unique values for 8-Tx UL operation. This embodiment may be useful in situations in which the UE 104 has two general regions in which all the antenna elements are located. For example, a first set of element pairs may be located in a first region of the UE and a second set of antenna element pairs may be located in a second region of the UE. Thus, a first unique value of the PCC matrix may apply to the antenna elements in the first region and the second unique value of the PCC matrix may apply to the antenna elements in the second region.

In a third option, the PCC matrix may contain Nₜ unique values. For example, the PCC matrix may include eight unique values for 8-Tx UL operation. In this instance, it may be assumed that the phase between any two antenna elements, V-Pol or H-Pol, are not calibrated. This option may provide the finest layer of granularity for compensating for phase error; however, it may also be associated with a relatively large overhead.

The number of unique diagonal elements used for phase calibration error compensation by the PCC matrix in a particular embodiment may be based on one or more of the following options.

In a first option, the number of unique diagonal elements in the PCC matrix may be hardcoded into a 3GPP TS. For example, for 8-Tx UL operation, a 3GPP TS may define the number of unique diagonal elements to be four. In other embodiments, other numbers may be used.

In a second option, the number of unique diagonal elements in the PCC matrix may be reported as a UE capability. For example, the UE 104 may transmit, to the base station 108, an indication that the UE 104 requires 2/4/8 unique phase calibration error compensations. This number may be set based on a specific antenna configuration at the UE 104.

In a third option, the number of unique diagonal elements in the PCC matrix may be configured by the base station 108 in, for example, an RRC message. In some embodiments, the network may also take into consideration UE capability reporting when providing this configuration. For example, if the UE 104 reports that the UE 104 requires four unique phase calibration error compensations, the network may configure the UE 104 with PCC matrixes that have at least four unique phase calibration error compensations. The network may configure the UE 104 with PCC matrixes that have more than the indicated number, as it will only increase the overhead of compensation. Thus, if the UE 104 indicates that it needs four unique phase calibration error compensations to obtain a desired level of uplink transmission quality, the base station 108 may configure the UE 104 with PCC matrixes that have four or eight unique phase calibration error compensations.

The mapping of the unique diagonal elements of the PCC matrix to Tx antenna ports may be performed in accordance with one or more of the following options.

In a first option, unique phase calibration error compensations may be first allocated to consecutive Tx antenna ports and then the pattern repeats itself.

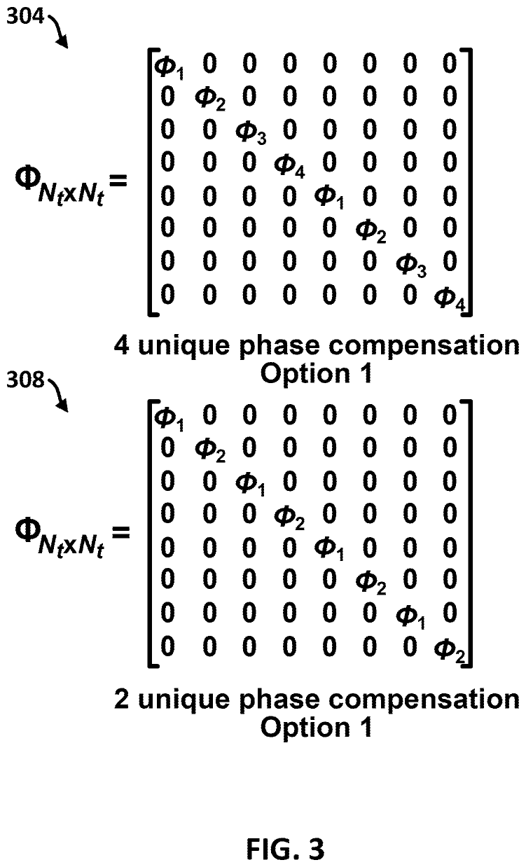

FIG. 3 illustrates PCC matrixes 304 and 308 with a mapping of the first option in accordance with some embodiments.

PCC matrix 304 has four unique phase compensation values, Φ₁−Φ₄. The four values may be sequentially mapped to the first four Tx antenna ports. For example, Φ₁ may be mapped to Tx antenna port 1, Φ₂ may be mapped to Tx antenna port 2, Φ₃ may be mapped to Tx antenna port 3, and Φ₄ may be mapped to Tx antenna port 4. Then the pattern of the values may be repeated with respect to the remaining Tx antenna ports. For example, Φ₁ may be mapped to Tx antenna port 5, Φ₂ may be mapped to Tx antenna port 6, Φ₃ may be mapped to Tx antenna port 7, and Φ₄ may be mapped to Tx antenna port 8.

In this embodiment, a pair of antenna elements (for example, a V-Pol and H-Pol antenna elements) may be associated with antenna ports i and i+4. For example, Tx antenna port 1 and Tx antenna port 5 may be associated with one pair of antenna elements.

PCC matrix 308 has two unique phase compensation values, Φ₁ and Φ₂. The two values may be sequentially mapped to the first two Tx antenna ports. For example, Φ₁ may be mapped to Tx antenna port 1, Φ₂ may be mapped to Tx antenna port 2. Then the pattern of the values may be repeated with respect to the next set of Tx antenna ports and so on. For example, Φ₁ may be mapped to Tx antenna port 3, Φ₂ may be mapped to Tx antenna port 4, Φ₁ may be mapped to Tx antenna port 5, Φ₂ may be mapped to Tx antenna port 6, Φ₁ may be mapped to Tx antenna port 7, and Φ₂ may be mapped to Tx antenna port 8.

In a second option, the same phase calibration error compensation may be first allocated to consecutive Tx antenna ports and then the pattern repeats for all the rest of the Tx antenna ports by assigning new unique phase calibration error compensations. Thus, in this embodiment, each phase compensation value is mapped to consecutive Tx antenna ports.

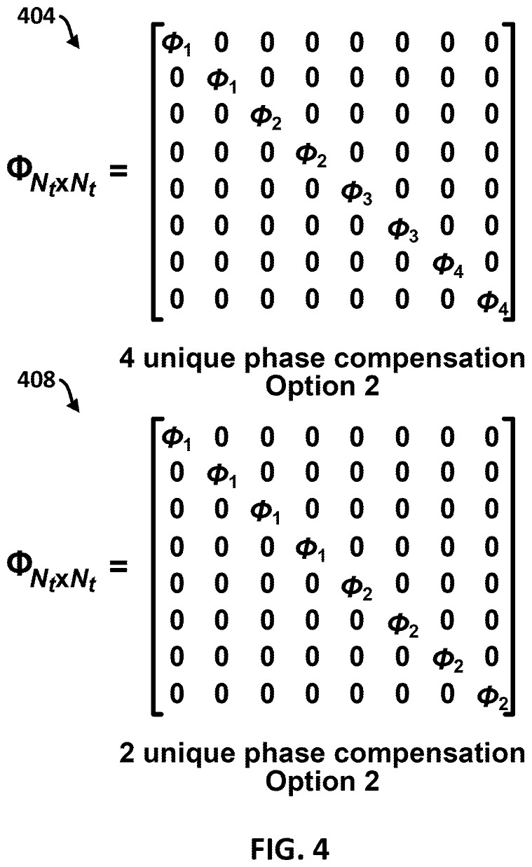

FIG. 4 illustrates PCC matrixes 404 and 408 with a mapping of the second option in accordance with some embodiments.

PCC matrix 404 has four unique phase compensation values, Φₗ−Φ₄. A first value may be mapped to the first two consecutive Tx antenna ports; the second value may be mapped to the next two consecutive Tx antenna ports, and so on. For example, Φ₁ may be mapped to Tx antenna ports 1 and 2, Φ₂ may be mapped to Tx antenna ports 3 and 4, Φ₃ may be mapped to Tx antenna ports 5 and 6, and Φ₄ may be mapped to Tx antenna ports 7 and 8. Thus, in this mapping, each phase compensation value is mapped to two consecutive Tx antenna ports.

In this embodiment, a pair of antenna elements (for example, a V-Pol and H-Pol antenna elements) may be associated with consecutive antenna ports, for example, antenna ports i and i−1. For example, Tx antenna port 1 and Tx antenna port 2 may be associated with one pair of antenna elements.

PCC matrix 408 has two unique phase compensation values, Φ₁ and Φ₂. The first value may be mapped to the first four consecutive Tx antenna ports and the second value may be mapped to the next four consecutive Tx antenna ports. For example, Φ₁ may be mapped to Tx antenna ports 1-4, and Φ₂ may be mapped to Tx antenna ports 5-8. Thus, in this mapping, each phase compensation value is mapped to four consecutive Tx antenna ports.

The encoding of the unique diagonal elements of the PCC matrix may be as follows. In some embodiments, only the phase of the diagonal elements of the PCC matrix may need to be quantized and indicated as part of, or along with, the TPMI. Differential encoding may be used to quantize the phase. Thus, the first diagonal element, Φ₁, can be assumed to have 0 phase and may not need to be indicated. The remaining unique diagonal elements may be quantized and encoded based on a phase difference with respect to the first diagonal element.

In various embodiments the phase differences may be quantized with 1-bit encoding, 2-bit encoding, or 3-bit encoding. 1-bit encoding may indicate phase of {0, 180} degrees, for example, {1, −1}. 2-bit encoding may indicate phases of {0, 90, 180, 270} degrees, for example, {1, j, −1, −j}. 3-bit encoding may indicate phases of {0, 45, 90, 135, 180, 225, 275, 315} degrees, for example, {exp(j*0), exp(j*pi/4), exp (j*pi/2), exp(j*3pi/4), exp (j*pi), exp (j*5pi/4), exp(j*3pi/2), exp(j*7pi/4)}.

In some embodiments, an indication of the PCC matrix may be provided according to one or more of the following options.

In a first option, the baseline precoding matrix and the PCC matrix may be jointly encoded. For example, one matrix indicator (e.g., TPMI) may be used to indicate a PCC TPM from a codebook that includes all combinations of baseline precoding matrixes and PCC matrixes. For example, if there were nine baseline precoding matrixes and nine PCC matrixes, the codebook may include 81 PCC TPMs. The base station 108 may use a single field in DCI to indicate the PCC TPM that the UE 104 is to use for an PUSCH transmission.

In a second option, the base station 108 may use separate indicators for the baseline precoding matrix and the PCC matrix. For example, the base station 108 may provide a first indicator in a first DCI field for the baseline precoding matrix (for example, a TPMI) and a second indicator in a second DCI field for the PCC matrix (for example, a PCC matrix indicator).

As briefly mentioned above, in some embodiments, the PCC matrix may be used with a baseline precoding matrix of a DL/UL type I codebook. A DL type I codebook may rely on oversampling to address linear phase error. Linear phase error may be assumed for up to 4-Tx operation, as there is likely only two phases with respect to first and second pairs of H-Pol and V-Pol antenna elements. However, the linear assumption of phase error may not be equally applicable to 8-Tx operation. Further, given that the PCC matrix is designed to address phase error compensation, the oversampling may not be needed. Thus, in embodiments in which the baseline precoding matrix is selected from a DL/UL type I codebook, the codebook may be simplified to have an oversampling of 1 only, for example, O₁−O₂=1.

In some embodiments, phase calibration error compensation may be handled by using an uplink TPMI to select the baseline precoding matrix from a DL/UL type I multi-panel codebook, which may be similar to an existing DL type I multi-panel codebook. The number of panels may represent the number of unique phase calibration compensations. For example, when two phase calibration compensation is desired, N_{g}=2 panel DL/UL type I multi-panel codebook may be used for the UL TPMI, and when four phase calibration compensation is desired, N_{g}=4 panel DL/UL type I multi-panel codebook may be used for the UL TPMI. In this embodiment, Tx antenna elements disposed on a common antenna panel may be considered to have their phases calibrated with one another. However, the UE 104 may not be required to have antenna elements disposed on different panels in order to utilize the multi-panel codebook as described above. For example, antenna elements that are phase calibrated with one another may be considered to be disposed on a common antenna panel even if the architecture of the UE is not arranged as such.

When a DL/UL type I multi-panel codebook is used for UL TPMI to handle phase calibration error compensation, the number of panels (N_{g}) may be determined by one or more of the following options.

In a first option, the number of panels (e.g., the number of unique phase calibration error compensations) for the DL/UL type I multi-panel codebook may be reported as a UE capability. For example, the UE 104 may report as a UE capability whether it requires 2 or 4 panels for the DL/UL type I multi-panel codebook.

In a second option, the number of panels (e.g., the number of unique phase calibration error compensations) for the DL/UL type I multi-panel codebook may be configured by RRC signaling. The number of panels may be configured along with configuration of the DL/UL type I multi-panel codebook. The network may take into consideration the UE capability reporting. For example, if the UE 104 reports that it desires two panels to meet performance targets, the network may configure at least two panels for the DL/UL type I multi-panel codebook. The network may configure the UE 104 with UE 104 with more than the indicated number panels, as it will only increase the TPMI overhead. Thus, if the UE 104 indicates that it needs two panels (e.g., two unique phase calibration error compensations) to obtain a desired level of uplink transmission quality, the base station 108 may configure the UE 104 with two panels or four panels for the DL/UL type I multi-panel codebook.

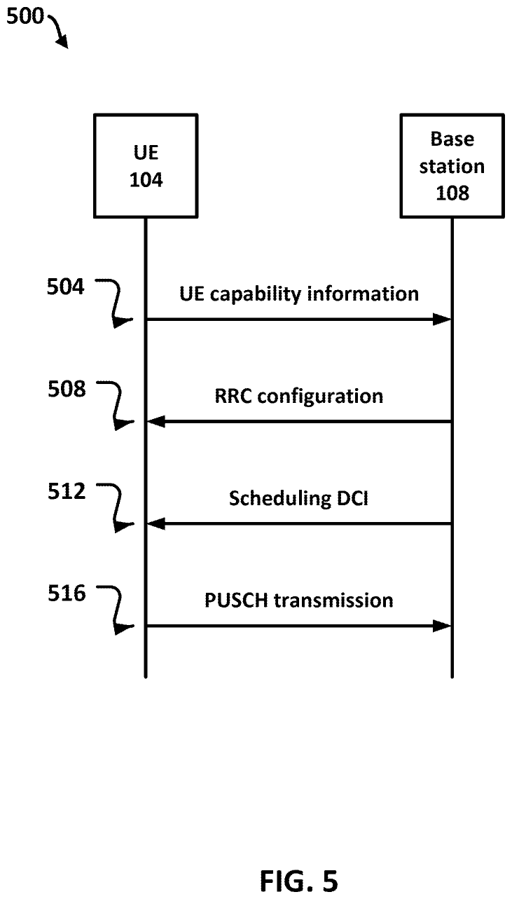

FIG. 5 illustrates a signaling diagram 500 in accordance with some embodiments. The signaling diagram 500 may include signals and operations with respect to the UE 104 and the base station 108.

The signaling diagram 500 may include, at 504, the UE 104 transmitting UE capability information to the base station 108. The UE capability information may provide an indication of a desired number of unique PCEC values to compensate for phase calibration errors in uplink transmissions. The UE capability information may include an indication of the desired number directly, or a desired number of panels.

The signaling diagram 500 may further include, at 508, the base station 108 transmitting an RRC configuration message. The RRC configuration message may configure the UE 104 with one or more codebooks. In some embodiments, the RRC configuration message may configure the UE 104 with a codebook having matrixes that combine aspects of a baseline precoding matrix and a PCC matrix. In other embodiments, the RRC configuration message may configure the UE 104 with a first codebook having baseline precoding matrixes and a second codebook having PCC matrixes. In various embodiments, the codebooks may be specific to uplink transmissions, or may be used for both uplink and downlink transmissions.

The signaling diagram 500 may further include, at 512, the base station 108 transmitting scheduling DCI to the UE 104. The scheduling DCI may provide an indication of uplink time/frequency resources that are scheduled for the UE 104 for purposes of transmitting a PUSCH transmission. The scheduling DCI may further include an indication of one or more precoding matrixes to use for the PUSCH transmission. The precoding matrixes may provide phase calibration error compensation as described herein.

In some embodiments, the DCI may provide an indication of a TPMI that references a baseline precoding matrix and further includes one or more PCEC values that may be used to construct an accompanying PCC matrix. The indication of the TPMI and PCEC values may be provided in the same message or in different messages.

The base station 108 may select the baseline precoding matrix based on uplink reference signals (for example, sounding reference signals) transmitted by the UE 104.

Additionally/alternatively, the base station 108 may select the baseline precoding matrix that corresponds to matrixes used for downlink transmissions, based on an uplink/downlink channel reciprocity assumption.

The UE 104 may use the indications in the DCI to determine a PCC TPM as described elsewhere herein.

The signaling diagram 500 may further include the UE 104 transmitting a PUSCH transmission at 516. The PUSCH transmission may be based on a PCC TPM using, for example, 8-Tx uplink operation.

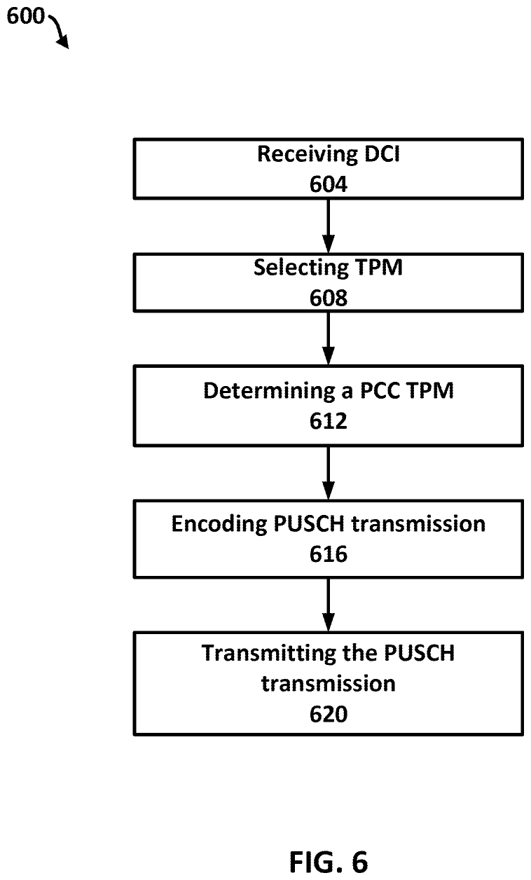

FIG. 6 is an operation flow/algorithmic structure 600 in accordance with some aspects. The operation flow/algorithmic structure 600 may be performed or implemented by a UE, such as UE 104 or 800; or components thereof; for example, baseband processor 804A.

The operation flow/algorithmic structure 600 may include, at 604, receiving DCI. The DCI may be received from the base station to schedule a PUSCH transmission. The DCI may have one or more indicators disposed in one or more fields. In some embodiments, the DCI may include one field having a TPMI. In other embodiments, the DCI may include a first field having a TPMI and a second field having a PCC matrix indicator. In some embodiments, the DCI (or other signaling) may directly include differentially-encoded PCEC values. Each PCEC value may be quantized with 1-bit, 2-bits, or 3-bits. If the PCC matrix includes N_{pcc} unique PCEC values, the first value may be set to zero and the remaining N_{pcc}-1 values may be signaled to the UE.

The operation flow/algorithmic structure 600 may further include, at 608, selecting a TPM based on the one or more indicators. For example, the TPM may be selected from the codebook based on a TPMI included in the DCI.

The operation flow/algorithmic structure 600 may further include, at 612, determining a PCC TPM that is configured to provide transmit precoding while compensating for phase calibration errors among eight or more transmit antenna ports. The PCC TPM may be determined by a product of a baseline precoding matrix and a PCC matrix as discussed herein. The PCC matrix may be selected from a codebook stored at the UE and referenced by an indicator in the DCI, or from encoded PCEC values in the DCI or other signaling. In some embodiments, the TPM selected at 608 may correspond to the baseline precoding matrix or the PCC TPM.

The PCC matrix may be a diagonal matrix with a plurality of non-zero PCEC values. The plurality of non-zero PCEC values may include N_{pcc} unique values. If the UE comprises N₁, transmit ports, where N, is equal to or greater than eight, then N_{pcc} may be less than Nₜ/2; equal to Nₜ/2; or equal to Nₜ.

In some embodiments, the UE may provide the base station with an indication that it desire a first number of unique PCEC values to compensate for phase calibration errors. The base station may thereafter configure the UE with a PCC matrix having at least the first number of unique PCEC values.

The unique PCEC values may map to Tx antenna ports in various ways. Consider, for example, that the UE includes eight transmit ports arranged in one or more sets with each set including the same number of transmit ports as the number of unique PCEC values. For example, if there are four unique PCEC values, the eight transmit ports may be arranged in two sets, each set having four transmit ports. The four PCEC values may then be sequentially mapped with the four consecutive transmit ports of the first set, then the four PCEC values may be sequentially mapped with the four consecutive transmit ports of the second set.

In another example, the eight transmit ports may be arranged in a number of sets that equals the number of unique PCEC values. For example, if there are four PCEC values, the eight transmit ports may be arranged in four sets. Each set may include consecutive transmit ports. Then a first PCEC value may be mapped to the consecutive transmit ports of the first set, the second PCEC value may be mapped to the consecutive transmit ports of the second set, and so on.

The operation flow/algorithmic structure 600 may further include, at 616, encoding a PUSCH transmission. The UE may use the PCC TPM to encode the PUSCH transmission on time/frequency resources indicated by the scheduling DCI.

The operation flow/algorithmic structure 600 may further include, at 620, transmitting the PUSCH transmission. The PUSCH transmission may be transmitted using eight or more Tx antenna ports/elements. The eight or more transmit antenna elements may be disposed on a plurality of antenna panels. In some embodiments, a plurality of non-zero PCEC values of a PCC matrix may respectively correspond to the plurality of antenna panels.

In these embodiments, the UE may access a DL/UL type I multi-panel codebook, which may be at least similar to, or based on, a DL type I multi-panel codebook.

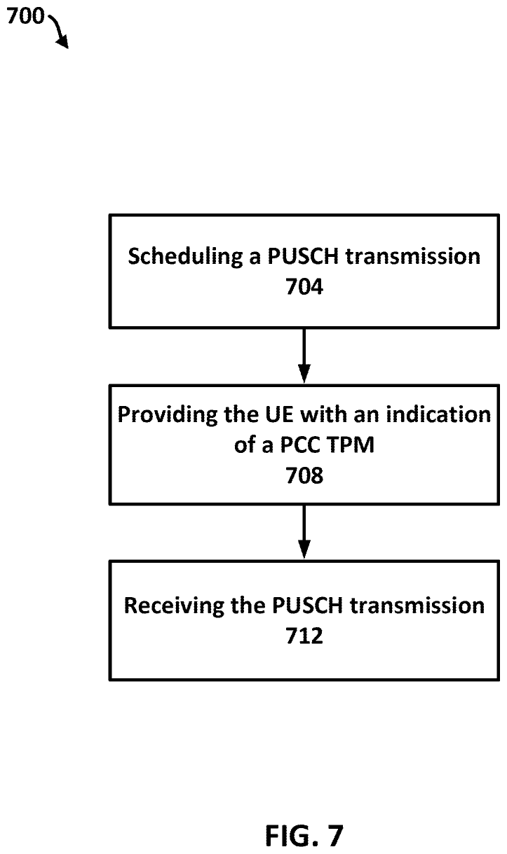

FIG. 7 illustrates an operation flow/algorithmic structure 700 in accordance with some aspects. The operation flow/algorithmic structure 700 may be performed or implemented by a base station, such as base station 108 or 900; or components thereof; for example, baseband processor 904A.

The operation flow/algorithmic structure 700 may include, at 704, scheduling a PUSCH transmission. The PUSCH transmission may be scheduled for transmission by a UE using eight or more transmit elements.

The operation flow/algorithmic structure 700 may further include, at 708, providing the UE with an indication of a PCC TPM. In some embodiments, the indication of the PCC TPM may be accomplished by separately indicating a PCC matrix (with a PCC matrix indicator) and a TPM (with a TPMI). The PCC matrix indicator and the TPMI may be provided in separate fields of a DCI, for example, the DCI used to schedule the PUSCH transmission. In other embodiments, the indication of the PCC TPM may be accomplished by sending a TPMI that references a codebook that includes PCC TPMs. The PCC TPMs of the codebook may be obtained as products of legacy TPMs with PCC matrixes. In still other embodiments, the indication of the PCC TPM may be accomplished by indicating a TPM (with a TPMI) and signaling differentially encoded PCEC values of a PCC matrix.

In some embodiments, the PCC TPM indicated may be based on UE capabilities received from the UE. For example, the UE may provide the base station with a request for a PCC matrix (or equivalent phase compensation) with at least a certain number of unique PCEC values. The base station may then configure the PCC TPM based on a PCC matrix having at least the number of unique PCEC values. In some instances, the base station may provide more than the requested number of unique PCEC values.

The operation flow/algorithmic structure 700 may further include, at 712, receiving the PUSCH transmission. The PUSCH transmission may be transmitted via the eight or more antenna elements using the indicated PCC TPM.

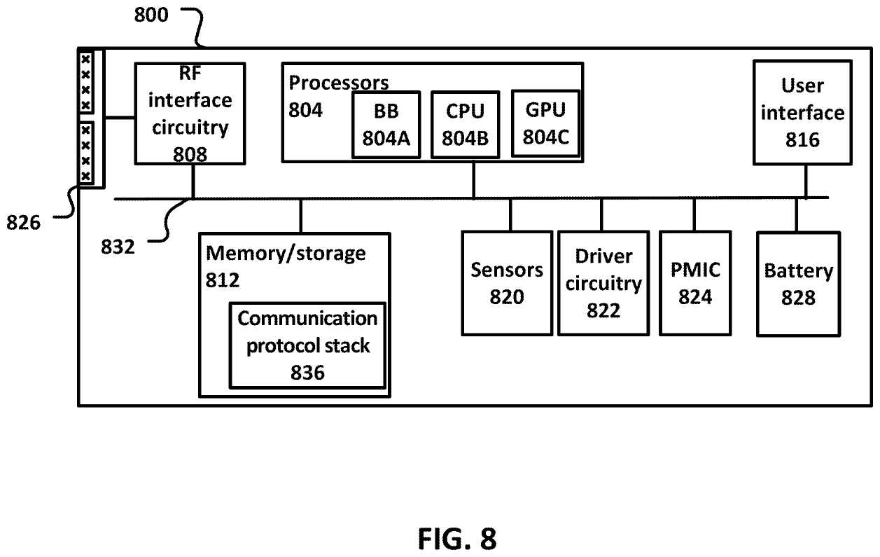

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform various operations described herein. The memory/storage 812 include any type of volatile or non-volatile memory that may be distributed throughout the UE 800. In some embodiments, some of the memory/storage 812 may be located on the processors 804 themselves (for example, Ll and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the

RFEM. The RFEM may amplify the RF signal through a power amplifier prior to the signal being radiated across the air interface via the antenna structure 826.

In various embodiments, the RF interface circuitry 808 may be configured to transmit/receive signals in a manner compatible with NR access technologies.

The antenna structure 826 may include antenna elements to convert electrical signals into radio waves to travel through the air and to convert received radio waves into electrical signals. The antenna elements may be arranged into one or more antenna panels. The antenna structure 826 may have antenna panels that are omnidirectional, directional, or a combination thereof to enable beamforming and multiple input, multiple output communications. The antenna structure 826 may include microstrip antennas, printed antennas fabricated on the surface of one or more printed circuit boards, patch antennas, or phased array antennas. The antenna structure 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within, or connected to, the UE 800. For example, the driver circuitry 822 may include circuitry to facilitate coupling of a UICC (for example, UICC 88) to the UE 800. For additional examples, driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800 including DRX as discussed herein.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

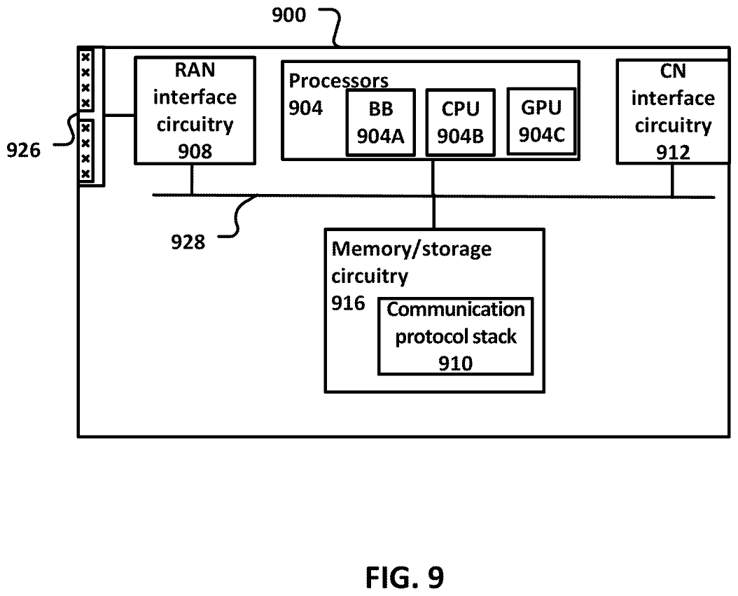

FIG. 9 illustrates a base station 900 in accordance with some embodiments. The base station 900 may be similar to and substantially interchangeable with base station 108.

The base station 900 may include processors 904, RF interface circuitry 908 (if implemented as an access node), core network (CN) interface circuitry 912, memory/storage circuitry 916, and antenna structure 926.

The components of the base station 900 may be coupled with various other components over one or more interconnects 928.

The processors 904, RF interface circuitry 908, memory/storage circuitry 916 (including communication protocol stack 910), antenna structure 926, and interconnects 928 may be similar to like-named elements shown and described with respect to FIG. 8.

The CN interface circuitry 912 may provide connectivity to a core network, for example, a 5th Generation Core network (5GC) using a 5GC-compatible network interface protocol such as carrier Ethernet protocols, or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the base station 900 may be coupled with transmit receive points (TRPs) using the antenna structure 926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: receiving downlink control information (DCI) having one or more indicators, the DCI to schedule a physical uplink shared channel (PUSCH) transmission; selecting a transmit precoding matrix (TPM) based on the one or more indicators; and determining, based on the TPM, a phase calibration compensation (PCC) TPM that is configured to compensate for phase calibration errors among eight or more transmit antenna ports; encoding the PUSCH transmission for transmission via eight or more transmit ports based on the PCC TPM; and transmitting the PUSCH transmission via eight or more transmit elements that respectively correspond to the eight or more transmit ports.

Example 2 includes the method of example 1 or some other example herein, wherein the one or more indicators comprise a transmit precoding matrix indicator (TPMI) associated with a TPM and the PCC TPM corresponds to, or is based on, the TPM.

Example 3 includes the method of example 2 or some other example herein, wherein the one or more indicators further comprise a PCC indicator (PCCI) associated with a PCC matrix and the method further comprises: generating the PCC TPM based on the PCC matrix and the TPM.

Example 4 includes the method of example 3 or some other example herein, wherein the PCC matrix is a diagonal matrix having a plurality of non-zero phase calibration error compensation (PCEC) values.

Example 5 includes the method of example 4 some other example herein, wherein: the eight or more transmit elements are disposed on a plurality of antenna panels; the plurality of non-zero PCEC values respectively correspond to the plurality of antenna panels; and accessing a downlink/uplink (DL/UL) type I multi-panel codebook based on the TPMI to determine the TPM.

Example 6 includes the method of example 5 or some other example herein, further comprising: transmitting, to the base station, an indication of a number of the plurality of antenna panels; and receiving, from the base station, radio resource control (RRC) signaling to construct the DL/UL type I multi-panel codebook for at least the number of the plurality of antenna panels.

Example 7 includes the method of example 4 some other example herein, wherein a first non-zero PCEC value of the plurality of PCEC values is to compensate for a first phase calibration error between a first transmit port and a second transmit port of the eight or more transmit elements.

Example 8 includes the method of example 4 some other example herein, wherein the eight or more transmit ports comprises Nₜ transmit ports, and the plurality of non-zero elements comprise N_{pcc} unique values, where N_{pcc} is: less than Nₜ/2; equal to Nₜ/2; or equal to Nₜ.

Example 9 includes the method of example 4 some other example herein, wherein the plurality of non-zero PCEC values comprises a first plurality of non-zero PCEC values and the method further comprises: transmitting, to the base station, a request for at least a second plurality of unique PCEC values, wherein the first plurality is equal to or greater than the second plurality.

Example 10 includes the method of example 4 some other example herein, wherein the eight or more transmit ports comprise one or more sets of transmit ports, a first set of the one or more sets having a plurality of consecutive transmit antenna ports, and the plurality of non-zero PCEC values are sequentially mapped with the plurality of consecutive transmit antenna ports.

Example 11 includes the method of example 4 some other example herein, wherein the eight or more transmit ports comprise one or more sets of transmit ports, a first set of the one or more sets having a plurality of consecutive transmit antenna ports, and a first non-zero PCEC value of the plurality of non-zero PCEC values being mapped with two or more consecutive transmit antenna ports of the plurality of consecutive transmit antenna ports.

Example 12 includes the method of example 2 or some other example herein, wherein the one or more indicators further comprise a plurality of bits to indicate phase calibration error compensation values of a PCC matrix and the method further comprises: generating the PCC TPM based on the PCC matrix and the TPM.

Example 13 includes the method of example 12 or some other example herein, wherein the plurality of bits comprise one, two, or three bits for each PCEC value of the plurality of PCEC values.

Example 14 includes method of example 13 or some other example herein, wherein the PCC matrix includes a first plurality of non-zero PCEC values and the plurality of bits are to signal a second plurality of PCEC values, the second plurality being one less than the first plurality.

Example 15 includes the method of example 2 or some other example herein, further comprising: accessing a downlink/uplink (DL/UL) type I codebook with an oversampling of one based on the TPMI to determine the TPM.

Example 16 includes a method of operating a base station, the method comprising: scheduling a physical uplink shared channel (PUSCH) transmission that is to be transmitted from a user equipment (UE) via eight or more transmit elements; providing the UE with an indication of a phase calibration compensation (PCC) transmit precoding matrix (TPM); and receiving the PUSCH transmission from the UE.

Example 17 includes the method of example 16 or some other example herein, wherein providing the indication comprises: transmitting downlink control information (DCI) with one or more indicators, the one or more indicators to include a transmit precoding matrix indicator (TPMI) associated with a TPM and the PCC TPM corresponds to, or is based on, the TPM.

Example 18 includes the method of example 17 or some other example herein, wherein the one or more indicators further comprise a PCC indicator (PCCI) associated with a PCC matrix, and the PCC TPM is based on the PCC matrix and the TPM.

Example 19 includes the method of example 18 or some other example herein, wherein the PCC matrix is a diagonal matrix having a plurality of non-zero phase calibration error compensation (PCEC) values.

Example 20 includes the method of example 19 or some other example herein, wherein the eight or more transmit elements are disposed on a plurality of antenna panels, the plurality of non-zero PCEC values respectively correspond to the plurality of antenna panels, and the method further comprises: receiving, from the UE, an indication of a number of the plurality of antenna panels; and transmitting radio resource control (RRC) signaling to the UE to configure the UE with a downlink/uplink (DL/UL) type I multi-panel codebook for at least the number of the plurality of antenna panels.

Example 21 includes the method of example 19 or some other example herein, wherein a first non-zero PCEC value of the plurality of PCEC values is to compensate for a first phase calibration error between a first transmit port and a second transmit port of the eight or more transmit elements.

Example 22 includes the method of example 19 or some other example herein, wherein the eight or more transmit ports comprises N, transmit ports, and the plurality of non-zero elements comprise N_{pcc} unique values, where N_{pcc} is: less than Nₜ/2; equal to Nₜ/2; or equal to Nt.

Example 23 includes the method of example 19 or some other example herein, wherein the plurality of non-zero PCEC values comprises a first plurality of non-zero PCEC values and the method further comprises: receiving, from the UE, a request for at least a second plurality of unique PCEC values, wherein the first plurality is equal to or greater than the second plurality.

Example 24 includes the method of example 17 or some other example herein, wherein the one or more indicators further comprise a plurality of bits to indicate phase calibration error compensation values of a PCC matrix.

Example 25 includes the method of example 24 some other example herein, wherein the plurality of bits comprise one, two, or three bits for each PCEC value of the plurality of PCEC values.

Example 26 includes the method of example 24 some other example herein, wherein the PCC matrix includes a first plurality of non-zero PCEC values and the plurality of bits are to signal a second plurality of PCEC values, the second plurality being one less than the first plurality. Another example may include an apparatus comprising means to perform one or more elements of a method described in or related to any of examples 1-26, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Another example may include an apparatus comprising logic, modules, or circuitry to perform one or more elements of a method described in or related to any of examples 1-26, or any other method or process described herein.

Another example may include a method, technique, or process as described in or related to any of examples 1-26, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-26, or portions thereof.

Another example include a signal as described in or related to any of examples 1-26, or portions or parts thereof.

Another example may include a datagram, information element, packet, frame, segment, PDU, or message as described in or related to any of examples 1-26, or portions or parts thereof, or otherwise described in the present disclosure.

Another example may include a signal encoded with data as described in or related to any of examples 1-26, or portions or parts thereof, or otherwise described in the present disclosure.

Another example may include a signal encoded with a datagram, IE, packet, frame, segment, PDU, or message as described in or related to any of examples 1-26, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Another example may include a computer program comprising instructions, wherein execution of the program by a processing element is to cause the processing element to carry out the method, techniques, or process as described in or related to any of examples 1-26, or portions thereof.

Another example may include a signal in a wireless network as shown and described herein.

Another example may include a method of communicating in a wireless network as shown and described herein.

Another example may include a system for providing wireless communication

as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-25. (canceled)

26. One or more non-transitory, computer-readable media having instructions that, when executed, cause processor circuitry to:
receive downlink control information (DCI) having one or more indicators, the DCI to schedule a physical uplink shared channel (PUSCH) transmission;
select a transmit precoding matrix (TPM) based on the one or more indicators;
determine, based on the TPM, a phase calibration compensation (PCC) TPM that is configured to compensate for phase calibration errors among eight or more transmit antenna ports;
encode the PUSCH transmission for transmission via eight or more transmit ports based on the PCC TPM; and
cause the PUSCH transmission to be transmitted via eight or more transmit elements that respectively correspond to the eight or more transmit ports.

27. The one or more non-transitory, computer-readable media of claim 26, wherein the one or more indicators comprise a transmit precoding matrix indicator (TPMI) associated with a TPM and the PCC TPM corresponds to, or is based on, the TPM.

28. The one or more non-transitory, computer-readable media of claim 27, wherein the one or more indicators further comprise a PCC indicator (PCCI) associated with a PCC matrix and the instructions, when executed, further cause the processor circuitry to:
generate the PCC TPM based on the PCC matrix and the TPM.

29. The one or more non-transitory, computer-readable media of claim 28, wherein the PCC matrix is a diagonal matrix having a plurality of non-zero phase calibration error compensation (PCEC) values.

30. The one or more non-transitory, computer-readable media of claim 29, wherein: the eight or more transmit elements are disposed on a plurality of antenna panels; the plurality of non-zero PCEC values respectively correspond to the plurality of antenna panels; and the instructions, when executed, further cause the processor circuitry to:
access a downlink/uplink (DL/UL) type I multi-panel codebook based on the TPMI to determine the TPM.

31. The one or more non-transitory, computer-readable media of claim 30, wherein the instructions, when executed, further cause the processor circuitry to:
generate, for transmission to a base station, an indication of a number of the plurality of antenna panels; and
receive, from the base station, radio resource control (RRC) signaling to construct the DL/UL type I multi-panel codebook for at least the number of the plurality of antenna panels.

32. The one or more non-transitory, computer-readable media of claim 29, wherein a first non-zero PCEC value of the plurality of PCEC values is to compensate for a first phase calibration error between a first transmit port and a second transmit port of the eight or more transmit elements.

33. The one or more non-transitory, computer-readable media of claim 29, wherein the eight or more transmit ports comprises Nt transmit ports, and the plurality of non-zero PCEC values comprise N_{pcc} unique values, where N_{pcc} is: less than Nₜ2; equal to Nₜ/2; or equal to Nₜ.

34. The one or more non-transitory, computer-readable media of claim 29, wherein the plurality of non-zero PCEC values comprises a first plurality of non-zero PCEC values and the instructions, when executed, further cause the processor circuitry to:
generate, for transmission to a base station, a request for at least a second plurality of unique PCEC values,
wherein the first plurality is equal to or greater than the second plurality.

35. The one or more non-transitory, computer-readable media of claim 29, wherein the eight or more transmit ports comprise one or more sets of transmit ports, a first set of the one or more sets having a plurality of consecutive transmit antenna ports, and the plurality of non-zero PCEC values are sequentially mapped with the plurality of consecutive transmit antenna ports.

36. The one or more non-transitory, computer-readable media of claim 29, wherein the eight or more transmit ports comprise one or more sets of transmit ports, a first set of the one or more sets having a plurality of consecutive transmit antenna ports, and a first non-zero PCEC value of the plurality of non-zero PCEC values being mapped with two or more consecutive transmit antenna ports of the plurality of consecutive transmit antenna ports.

37. The one or more non-transitory, computer-readable media of claim 27, wherein the one or more indicators further comprise a plurality of bits to indicate phase calibration error compensation (PCEC) values of a PCC matrix and the instructions, when executed, further cause the processor circuitry to:
generate the PCC TPM based on the PCC matrix and the TPM,
wherein the plurality of bits comprise one, two, or three bits for each PCEC value of the plurality of PCEC values, the PCC matrix includes a first plurality of non-zero PCEC values, and the plurality of bits are to signal a second plurality of PCEC values, the second plurality being one less than the first plurality.

38. The one or more non-transitory, computer-readable media of claim 27, wherein the instructions, when executed, further cause the processor circuitry to:
access a downlink/uplink (DL/UL) type I codebook with an oversampling of one based on the TPMI to determine the TPM.

39. A method comprising:
scheduling a physical uplink shared channel (PUSCH) transmission that is to be transmitted from a user equipment (UE) via eight or more transmit elements;
providing the UE with an indication of a phase calibration compensation (PCC) transmit precoding matrix (TPM); and
receiving the PUSCH transmission from the UE.

40. The method of claim 39, wherein providing the indication comprises:
generating, for transmission to the UE, downlink control information (DCI) with one or more indicators, the one or more indicators to include a transmit precoding matrix indicator (TPMI) associated with a TPM and the PCC TPM corresponds to, or is based on, the TPM.

41. The method of claim 40, wherein the one or more indicators further comprise a PCC indicator (PCCI) associated with a PCC matrix, and the PCC TPM is based on the PCC matrix and the TPM.

42. The method of claim 41, wherein the PCC matrix is a diagonal matrix having a plurality of non-zero phase calibration error compensation (PCEC) values.

43. The method of claim 42, wherein the eight or more transmit elements are disposed on a plurality of antenna panels, the plurality of non-zero PCEC values respectively correspond to the plurality of antenna panels, and the method further comprises:
receiving, from the UE, an indication of a number of the plurality of antenna panels; and
generating, for transmission to the UE, radio resource control (RRC) signaling to configure the UE with a downlink/uplink (DL/UL) type I multi-panel codebook for at least the number of the plurality of antenna panels.

44. The method of claim 42, wherein a first non-zero PCEC value of the plurality of PCEC values is to compensate for a first phase calibration error between a first transmit port and a second transmit port of the eight or more transmit elements.

45. The method of claim 42, wherein the eight or more transmit ports comprises Nₜ transmit ports, and the plurality of non-zero PCEC values comprise N_{pcc} unique values, where N_{pcc} is: less than Nₜ2; equal to Nₜ/2; or equal to Nₜ.
